(19) United States
(12) Patent Application Publication
(10) Pub. No.: US 2014/0111619 A1
(43) Pub. Date: Apr. 24, 2014

(54) DEVICE AND METHOD FOR ACQUIRING IMAGE

(71) Applicant: Electronics And Telecommunications Research Institute, Daejeon (KR)

(72) Inventors: Dong Woo LEE, Daejeon (KR); Hyun Tae JEONG, Daejeon (KR); Yong-Ki SON, Daejeon (KR); IL YEON CHO, Daejeon (KR)

(73) Assignee: Electronics And Telecommunications Research Institute, Daejeon (KR)

(21) Appl. No.: 14/057,128

(22) Filed: Oct. 18, 2013

(30) Foreign Application Priority Data
Oct. 19, 2012 (KR) 10-2012-0116775
Sep. 5, 2013 (KR) 10-2013-0106780

(51) Int. Cl. H04N 13/02

(52) U.S. Cl. CPC H04N 13/0203
USPC 348/46

(57) ABSTRACT

An image acquisition device is provided. The image acquisition device includes: a pattern generator that generates a plurality of incident light patterns using a plurality of light sources and that projects the generated plurality of incident light patterns to a target object; a pattern acquisition unit that acquires a pattern image that is formed in the target object by the plurality of incident light patterns; and an operation unit that generates a three-dimensional image of the target object using the pattern image.

### CROSS-REFERENCE TO RELATED APPLICATION

This application claims priority to and the benefit of Korean Patent Application No. 10-2012-0116775 and 10-2013-0106780 filed in the Korean Intellectual Property Office on Oct. 19, 2012 and Sep. 5, 2013, the entire contents of which are incorporated herein by reference.

### BACKGROUND OF THE INVENTION

(a) Field of the Invention

The present invention relates to an image acquisition device for acquiring a three-dimensional image of a target object and a method of acquiring an image of the target object.

(b) Description of the Related Art

Various methods of acquiring a three-dimensional depth image of a target object exist. Specifically, a method of using a stereo camera, a method of using a time of flight (TOF) camera, and a method of using a specific pattern that is projected to a target object exist.

Various methods of projecting a pattern to a target object exist. For example, there are methods that are described in a treatise “A state of the art in structured light patterns for surface profilometry” of Joaquim Salvi et al. and a treatise “Recent progress in coded structured light as a technique to solve the correspondence problem: a survey” of J. Battle et al.

Nowadays, as the Kinect sensor from Microsoft is on the market, the application field using three-dimensional depth images is remarkably increasing.

U.S. Patent Laid-Open Publication No. 2010/0118123 discloses a method of acquiring a three-dimensional depth image using a pattern that is formed with a code. An image acquisition device that is disclosed in U.S. Patent Laid-Open Publication No. 2010/0118123 includes a pattern projection device, a camera, and a processor. The pattern projecting apparatus projects a pattern to an object, the image acquiring unit acquires an image of the object to which the pattern is projected, and the processor generates a three-dimensional depth image of the object.

A conventional image acquisition device performs a complicated operation process so as to calculate a three-dimensional depth from a pattern that is projected to an object. Therefore, the conventional art requires a high performance of a processor so as to perform a complicated operation.

The conventional art has a limitation in resolution because of a physical size of a spot forming a projected pattern. Specifically, the conventional art uses one light source and a pattern projection device that projects one fixed pattern. In this case, x-axis and y-axis resolutions of three-dimensional image information that can be obtained from a projected pattern are determined by the resolution of a camera, the size of a spot forming a projected pattern, and the size of a code that is formed with spots of a pattern. Further, x-axis and y-axis resolutions of three-dimensional image information that can be obtained from the projected pattern become much lower than the resolution of the camera.

When the resolution of the camera is determined, the size of the spot and the size of the code that can read with the camera are determined. In a case in which an image is acquired though the camera, when a spot forming a pattern is separated from a neighboring spot, stable image processing can be performed, and an operation amount for image processing can be reduced. When a spot forming a pattern is adjacent to a neighboring spot or is overlapped with a neighboring spot, an error of spot detection increases in an image processing process, and in order to process the error, a more complicated operation is performed.

### SUMMARY OF THE INVENTION

The present invention has been made in an effort to provide a device and method for acquiring an image having advantages of minimizing an operation amount for image processing and obtaining a three-dimensional depth image with high resolution.

An exemplary embodiment of the present invention provides an image acquisition device. The image acquisition device includes: a pattern generator that generates a plurality of incident light patterns using a plurality of light sources and that projects the generated plurality of incident light patterns to a target object; a pattern acquisition unit that acquires a pattern image that is formed in the target object by the plurality of incident light patterns; and an operation unit that generates a three-dimensional image of the target object using the pattern image.

The plurality of light sources may have different frequency bands, and the plurality of incident light patterns may correspond to the plurality of light sources, respectively, and may be different patterns.

The plurality of light sources may include a first light source having a first frequency band and a second light source having a second frequency band. The pattern generator may include: a first lens that concentrates light from the first light source; a first optical diffraction unit that generates a first incident light pattern of the plurality of incident light patterns by diffracting light that is concentrated by the first lens; and a first mirror that reflects only the first incident light pattern having the first frequency band.

The pattern generator may further include: a second lens that concentrates light from the second light source; and a second optical diffraction unit that generates a second incident light pattern of the plurality of incident light patterns by diffracting light that is concentrated by the second lens. The second incident light pattern may be transmitted through the first mirror.

The pattern generator may further include a third lens that receives an input of the first incident light pattern that is reflected by the first mirror and the second incident light pattern that is transmitted through the first mirror to project the first incident light pattern and the second incident light pattern to the target object.

The first light source may be one of a light emitting diode (LED) light source and a laser light source, and the second light source may be one of the LED light source and the laser light source.

The pattern acquisition unit may include a first mirror that reflects only light of the first frequency band, and a first image sensor that acquires a first image corresponding to the first light source of the pattern image through light that is reflected by the first mirror.

The pattern acquisition unit may further include a second image sensor that acquires a second image corresponding to the second light source of the pattern image through light of the second frequency band that is transmitted through the first mirror.

The plurality of incident light patterns may each correspond to each of different information sets necessary for generating the three-dimensional image.

Another embodiment of the present invention provides a method of acquiring an image of an image acquisition device that acquires a three-dimensional image of a target object. The method includes: generating a first incident light pattern using first light of a first frequency band in which a first light source emits light; generating a second incident light pattern different from the first incident light pattern using second light of a second frequency band in which a second light source emits light; projecting the first incident light pattern and the second incident light pattern to the target object; acquiring a pattern image that is formed in the target object by the first incident light pattern and the second incident light pattern; and generating a three-dimensional image of the target object using the pattern image.

Yet another embodiment of the present invention provides a pattern generator that forms an image acquisition device that acquires a three-dimensional image of a target object and that generates an incident light pattern that is projected to the target object. The pattern generator includes: a first lens that concentrates first light of a first frequency band from a first light source; a second lens that concentrates second light of a second frequency band from a second light source; a third lens that concentrates third light of a third frequency band from a third light source; an optical diffraction unit that generates a first incident light pattern by diffracting first light that is concentrated by the first lens, that generates a second incident light pattern by diffracting second light that is concentrated by the second lens, and that generates a third incident light pattern by diffracting third light that is concentrated by the third lens; a first dichroic mirror that reflects only the first incident light pattern; and a second dichroic mirror that reflects only the second incident light pattern. The second incident light pattern may be transmitted through the first dichroic mirror, and the third incident light pattern may be transmitted through the first and second dichroic mirrors. The first to third incident light patterns may be different patterns.

### BRIEF DESCRIPTION OF THE DRAWINGS

FIG. 1 is a diagram illustrating an image acquisition device according to an exemplary embodiment of the present invention.

FIG. 2 is a diagram illustrating an exemplary embodiment of a pattern generator of FIG. 1.

FIG. 3 is a diagram illustrating another exemplary embodiment of a pattern generator of FIG. 1.

FIG. 4 is a diagram illustrating an exemplary embodiment of a pattern acquisition unit of FIG. 1.

FIG. 5 is a diagram illustrating another exemplary embodiment of a pattern acquisition unit of FIG. 1.

FIG. 6 is a diagram illustrating an exemplary embodiment of pattern generation using a plurality of light sources.

FIG. 7 is a flowchart illustrating an image acquiring process according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

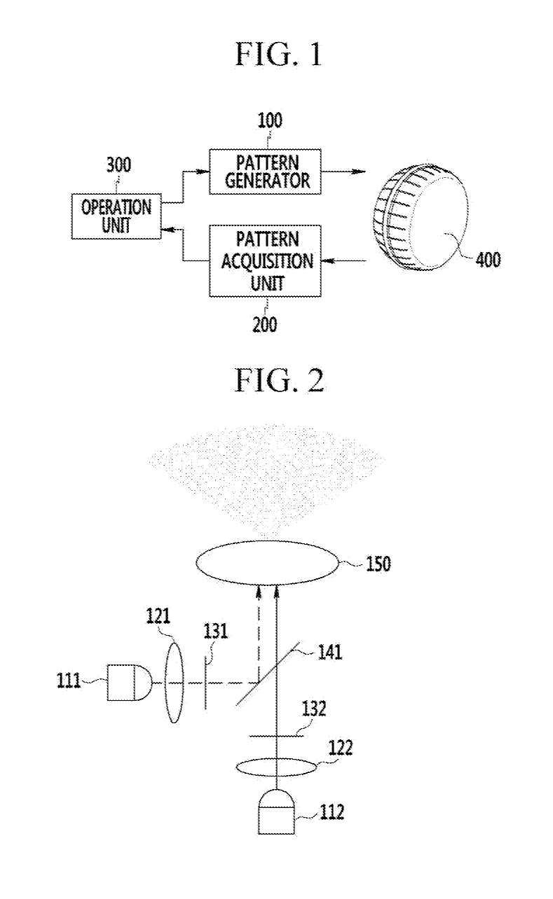

FIG. 1 is a diagram illustrating an image acquisition device according to an exemplary embodiment of the present invention.

The image acquisition device according to an exemplary embodiment of the present invention obtains a three-dimensional depth image of a target object 400 using a specific pattern (e.g., a random speckle pattern) that is projected to the target object 400.

The image acquisition device according to an exemplary embodiment of the present invention uses a plurality of light sources having different frequency characteristics and a plurality of different patterns.

In order to acquire a three-dimensional depth image of the target object 400, the image acquisition device may use an intensity change value according to a distance (a distance between a light source and the target object 400) of already known light sources, or may use a code of a projected incident light pattern. Because a method of using a change of intensity according to a distance is much affected by a peripheral environment, a method of using a coded incident light pattern like the present invention can reduce an error rate of image processing and more stably perform image processing.

The image acquisition device according to an exemplary embodiment of the present invention includes a pattern generator 100, a pattern acquisition unit 200, and an operation unit 300.

The pattern generator 100 includes a plurality of light sources. The pattern generator 100 generates a coded incident light pattern corresponding to each light source. Here, transmitted light patterns correspond to light sources, respectively, and are different patterns. Each of incident light patterns corresponds to each of information necessary for three-dimensional image processing. The pattern generator 100 projects a generated incident light pattern to the target object 400.

The pattern acquisition unit 200 acquires an image (hereinafter, referred to as a “pattern image”) of the target object 400 to which an incident light pattern is projected. Specifically, the pattern acquisition unit 200 separates and acquires a pattern image on each light source basis. That is, the pattern acquisition unit 200 acquires a pattern image corresponding to each light source.

The operation unit 300 generates a three-dimensional depth image of the target object 400 based on a two-dimensional pattern image of each light source that is acquired by the pattern acquisition unit 200.

FIG. 2 is a diagram illustrating an exemplary embodiment of the pattern generator 100 of FIG. 1. FIG. 2 illustrates a case in which the pattern generator 100 includes two light sources 111 and 112.

The pattern generator 100 includes the two light sources 111 and 112, two lenses 121 and 122, optical diffraction units 131 and 132, a dichroic mirror 141, and a lens 150.

Each of the light sources 111 and 112 emits light of different frequency bands. Specifically, the light source 111 emits light of a first frequency band, and the light source 112 emits light of a second frequency band. The light sources 111 and 112 may be one of a light emitting diode (LED) light source and a laser light source.

The lenses 121 and 122 respectively concentrate light that the light sources 111 and 112 emit. The lenses 121 and 122 may be collimator lenses that respectively convert light of the light sources 111 and 112 to parallel light.

The optical diffraction units 131 and 132 respectively generate incident light patterns by diffracting light that is concentrated by the lenses 121 and 122. Specifically, each of the optical diffraction units 131 and 132 includes a transparent optical element (not shown). The transparent optical element includes a plurality of micro-lenses. For example, the optical diffraction unit 131 may generate a first incident light pattern through a first transparent optical element including a plurality of micro-lenses that are arranged in a first pattern, and the optical diffraction unit 132 may generate a second incident light pattern different from a first incident light pattern through a second transparent optical element including a plurality of micro-lenses that are arranged in a second pattern different from the first pattern. Each of the optical diffraction units 131 and 132 may further include a diffuser that diffuses light that is concentrated by each of the lenses 121 and 122 and that outputs the diffused light to the transparent optical element. Each of the optical diffraction units 131 and 132 may be formed with a diffractive optical element (DOE).

The dichroic mirror 141 reflects only light of a specific frequency band. Specifically, the dichroic mirror 141 reflects a first incident light pattern that is output from the optical diffraction unit 131 and transmits a second incident light pattern that is output from the optical diffraction unit 132.

The lens 150 concentrates a first incident light pattern that is reflected by the dichroic mirror 141 and a second incident light pattern that is transmitted through the dichroic mirror 141 and projects the concentrated incident light pattern to the target object 400 at a predetermined incidence angle. In this case, the first incident light pattern and the second incident light pattern are combined into one and are projected to the target object 400.

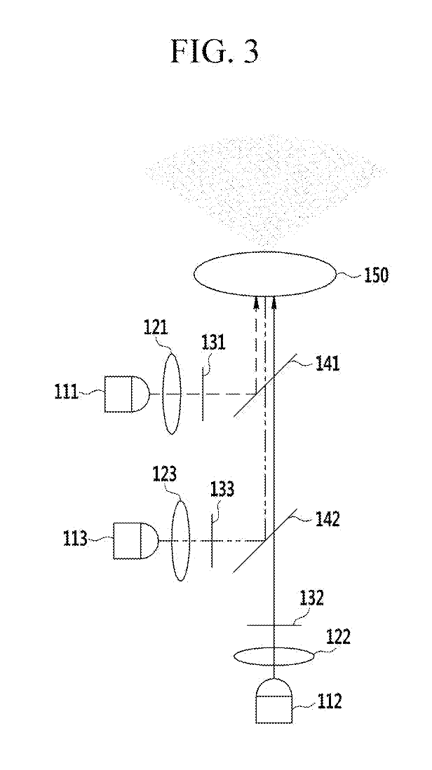

FIG. 3 is a diagram illustrating another exemplary embodiment of the pattern generator 100 of FIG. 1. FIG. 3 illustrates a case in which the pattern generator 100 includes three light sources 111, 112, and 113.

The pattern generator 100 of FIG. 3 further includes a light source 113, a lens 123, an optical diffraction unit 133, and a dichroic mirror 142, compared with the pattern generator 100 of FIG. 2. Hereinafter, in FIG. 3, different configurations from those of FIG. 2 will be described.

The light source 113 emits light of a different frequency band from that of the light sources 111 and 112. Specifically, the light source 113 emits light of a third frequency band. The light source 113 may be one of an LED light source and a laser light source.

The lens 123 concentrates light that the light source 113 emits.

The optical diffraction unit 133 generates a third incident light pattern by diffracting light that is concentrated by the lens 123. Here, the third incident light pattern is a different pattern from the first and second incident light patterns.

The dichroic mirror 142 reflects a third incident light pattern that is output from the optical diffraction unit 133 and transmits a second incident light pattern that is output from the optical diffraction unit 132. The dichroic mirror 141 transmits the third incident light pattern that is reflected by the dichroic mirror 142 and the second incident light pattern that is output from the optical diffraction unit 132.

The lens 150 concentrates the first incident light pattern that is reflected by the dichroic mirror 141, the third incident light pattern that is reflected by the dichroic mirror 142 and transmitted through the dichroic mirror 141, and the second incident light pattern that is transmitted through the dichroic mirrors 141 and 142, and projects the concentrated incident light pattern to the target object 400 at a predetermined incidence angle. In this case, the first to third incident light patterns are combined into one and are projected to the target object 400.

FIGS. 2 and 3 illustrate a case in which the number of light sources is 2-3, but the number of light sources may be increased or decreased as needed.

The pattern generator 100 of FIGS. 2 and 3 finally projects an incident light pattern that is combined into one through the lens 150 to the target object 400. Such a structure is one in which a plurality of light sources 111-113 are designed to operate like one light source. Unlike the structure of FIGS. 2 and 3, the pattern generator 100 may be designed in a structure (i.e., a structure in which a plurality of light sources each independently operate) in which each of a plurality of light sources are disposed at different specific positions and in which each incident light pattern is thus projected to the target object 400 at different specific positions.

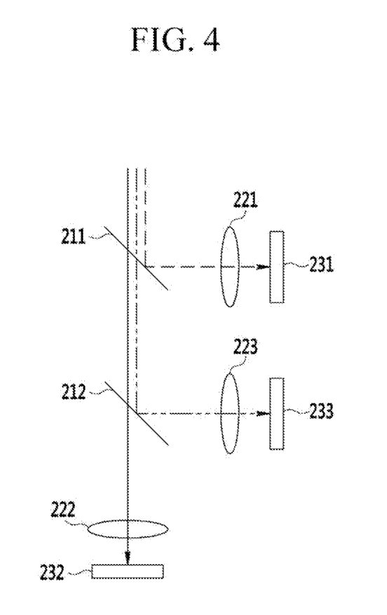

FIG. 4 is a diagram illustrating an exemplary embodiment of the pattern acquisition unit 200 of FIG. 1.

The pattern acquisition unit 200 includes image sensors 231-233 of the same number as that of the light sources 111-113 of the pattern generator 100. FIG. 4 illustrates the pattern acquisition unit 200 including three image sensors 231-233 to correspond to the pattern generator 110 using three light sources 111-113. The number of modules of the image sensors 231-233 of the pattern acquisition unit 200 may be increased and decreased according to the number of the light sources 111-113 of the pattern generator 100.

The pattern acquisition unit 200 includes two dichroic mirrors 211 and 212, three lenses 221-223, and three image sensors 231-233.

The pattern acquisition unit 200 separates a pattern image corresponding to each light source from a pattern image that is projected to the target object 400. Specifically, the pattern acquisition unit 200 enables only light of a specific frequency band to be transferred to the image sensors 231-233 using the dichroic mirrors 211 and 212. Thereby, each of the image sensors 231-233 can separate and receive a pattern image corresponding to each of the light sources 111-113 from a pattern image that is projected to the target object 400.

Specifically, the dichroic mirror 211 reflects only a first frequency band of light that the light source 111 emits. That is, the dichroic mirror 211 transmits a second frequency band of light that the light source 112 emits and a third frequency band of light that the light source 113 emits.

The lens 221 concentrates a first frequency band of light that is reflected by the dichroic mirror 211.

The image sensor 231 receives light that is concentrated by the lens 221. The image sensor 231 acquires a first pattern image corresponding to the light source 111 through the received light. Here, when the first incident light pattern is projected to the target object 400, the first pattern image corresponds to a pattern image that is formed in the target object 400.

The dichroic mirror 212 reflects only a third frequency band of light that the light source 113 emits. That is, the dichroic mirror 212 transmits a first frequency band of light that the light source 111 emits and a second frequency band of light that the light source 112 emits.

The lens 222 concentrates a second frequency band of light that is transmitted through the dichroic mirrors 211 and 212.

The image sensor 232 receives light that is concentrated by the lens 222. The image sensor 232 acquires a second pattern image corresponding to the light source 112 through the received light. When the second incident light pattern is projected to the target object 400, the second pattern image corresponds to a pattern image that is formed in the target object 400.

The lens 223 concentrates a third frequency band of light that is reflected by the dichroic mirror 212.

The image sensor 233 receives light that is concentrated by the lens 223. The image sensor 233 acquires a third pattern image corresponding to the light source 113 through the received light. When the third incident light pattern is projected to the target object 400, the third pattern image corresponds to a pattern image that is formed in the target object 400.

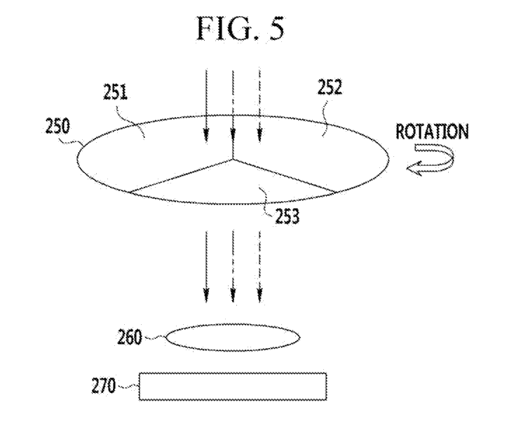

FIG. 5 is a diagram illustrating another exemplary embodiment of the pattern acquisition unit 200 of FIG. 1.

The pattern acquisition unit 200 includes a rotary filter 250 that has areas of the same number as that of the light sources 111-113 in the pattern generator 100. FIG. 5 illustrates the pattern acquisition unit 200 including the rotary filter 250 having three areas 251-253 to correspond to the pattern generator 100 using three light sources 111-113.

The pattern acquisition unit 200 includes the rotary filter 250, a lens 260, and an image sensor 270.

The rotary filter 250 includes three areas 251-253 to correspond to three light sources 111-113. Specifically, the area 251 of the rotary filter 250 transmits only a first frequency band of light that the light source 111 emits, the area 252 of the rotary filter 250 transmits only a second frequency band of light that the light source 112 emits, and the area 253 of the rotary filter 250 transmits only a third frequency band of light that the light source 113 emits. The rotary filter 250 is synchronized with the image sensor 270. Specifically, the rotary filter 250 rotates according to a preset time, and each of the areas 251-253 of the rotary filter 250 sequentially faces the image sensor 270. That is, at a first time, the area 251 of the rotary filter 250 faces the image sensor 270 and thus light (light of a first frequency band) that is transmitted through the area 251 arrives at the image sensor 270 via the lens 260. At a second time, the area 252 of the rotary filter 250 faces the image sensor 270 and thus light (light of a second frequency band) that is transmitted through the area 252 arrives at the image sensor 270 via the lens 260. At a third time, the area 253 of the rotary filter 250 faces the image sensor 270 and thus light (light of a third frequency band) that is transmitted through the area 253 arrives at the image sensor 270 via the lens 260.

The lens 260 concentrates light that is transmitted through the rotary filter 250.

The image sensor 270 receives light that is concentrated by the lens 260. The image sensor 270 acquires a pattern image corresponding to each of the light sources 111-113 through the received light.

Finally, as the pattern acquisition unit 200 of FIG. 5 synchronizes the rotary filter 250 and the image sensor 270, the pattern acquisition unit 200 separates and acquires a pattern image according to each of the light sources 111-113 using one image sensor 270.

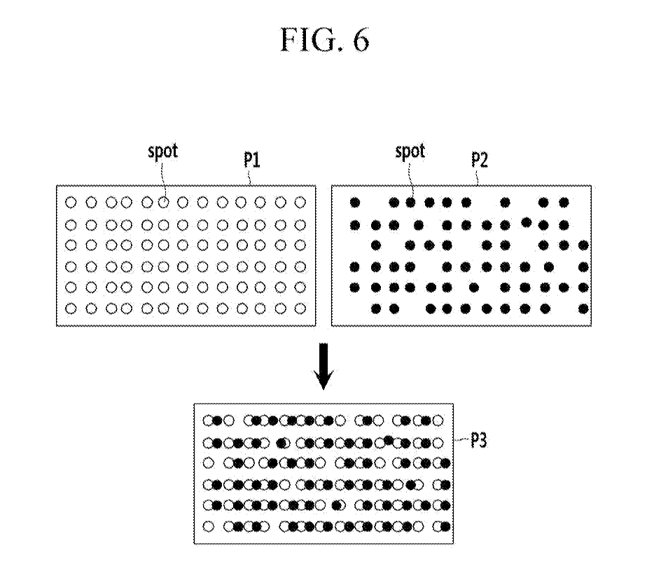

FIG. 6 is a diagram illustrating an exemplary embodiment of pattern generation using a plurality of light sources. FIG. 6 illustrates that the density of an incident light pattern that is projected to the target object 400 can be enhanced when generating an incident light pattern using a plurality of light sources 111-113. For convenience of description, FIG. 6 illustrates the density of an incident light pattern P3 when generating incident light patterns P1 and P2 using two light sources 111 and 112.

A first incident light pattern P1 corresponding to the light source 111 may be a uniform pattern in which spots are regularly arranged. A second incident light pattern P2 corresponding to the light source 112 may be a non-uniform pattern in which spots are irregularly arranged.

Like the incident light pattern P3, when the first incident light pattern P1 and the second incident light pattern P2 are simultaneously projected to the target object 400, the density of the incident light pattern P3 that is projected to the target object 400 can be enhanced.

A shape of a light pattern may have various forms including a circular spot form, a stripe (−) form, or a combination of different shapes.

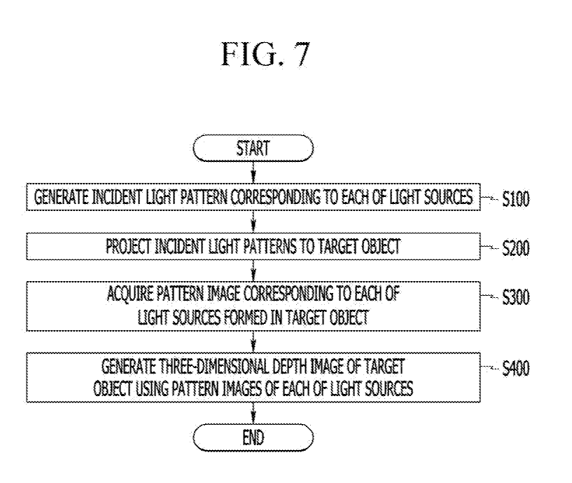

FIG. 7 is a flowchart illustrating an image acquiring process according to an exemplary embodiment of the present invention. Hereinafter, for convenience of description, a case in which the pattern generator 100 uses three light sources 111-113 is exemplified.

First, the pattern generator 100 generates an incident light pattern corresponding to each of the light sources 111-113 (S100). That is, the pattern generator 100 generates a first incident light pattern corresponding to the light source 111, a second incident light pattern corresponding to the light source 112, and a third incident light pattern corresponding to the light source 113.

The pattern generator 100 projects the first to third incident light patterns to the target object 400 (S200).

The pattern acquisition unit 200 separates and acquires a pattern image corresponding to each of the light sources 111-113 from a pattern image that is formed in the target object 400 by the first to third incident light patterns (S300). Specifically, the pattern acquisition unit 200 acquires a first pattern image corresponding to the light source 111, a second pattern image corresponding to the light source 112, and a third pattern image corresponding to the light source 113.

The operation unit 300 generates a three-dimensional depth image of the target object 400 using first to third pattern images, which are acquired two-dimensional images (S400).

As in the present invention, when generating an incident light pattern using a plurality of light sources 111-113, the density of an incident light pattern can be enhanced further than when generating an incident light pattern using one light source. Therefore, three-dimensional depth image information of a higher resolution than when using one light source can be obtained.

When an incident light pattern having high spot density is generated using one light source, spots may be attached into one or may be crushed, and thus an error rate of an image processing rises, whereby image processing may become impossible. However, in the present invention, because a plurality of incident light patterns are generated using a plurality of light sources 111-113 of different frequency bands, it is easy to separate and acquire a pattern image on each frequency band basis. Therefore, an error rate of an image processing is lowered, and image processing can be stably performed.

Further, the present invention differently generates each pattern corresponding to each information set necessary for three-dimensional image processing on each light source basis. Therefore, according to an exemplary embodiment of the present invention, image processing can be more efficiently performed than in a case of loading all information in one incident light pattern. Specifically, the operation unit 300 first processes approximate three-dimensional information through a first pattern image corresponding to the light source 111, and processes detailed three-dimensional information through second to third pattern images corresponding to other light sources 112 and 113. Further, for fast image processing, the pattern generator 100 may separate an incident light pattern of a uniform pattern and an incident light pattern of a non-uniform pattern, and may project the incident light pattern of a uniform pattern and the incident light pattern of a non-uniform pattern to the target object 400. In addition, the pattern generator 100 may generate an incident light pattern of information that is not apt to be extracted when information is mixed together in an image processing process to another pattern.

In the present invention, when processing an image of the operation unit 300, an intensity change value of a light source according to a distance (a distance between a light source and the target object 400) can be considered together. Therefore, by decreasing an image processing error, stability of image processing can be further enhanced and a more elaborate image can be acquired.

According to an exemplary embodiment of the present invention, a plurality of different incidence light patterns are generated using a plurality of light sources. Thereby, density of a spot forming a pattern of incident light can be enhanced further than in a case of generating one incident light pattern using one light source. Therefore, three-dimensional depth image information of a higher resolution can be acquired than in a case of using one light source. That is, when a resolution of a camera and a size of a spot are the same as those of the conventional art, a three-dimensional depth image of a higher resolution than that of the conventional art can be acquired according to an exemplary embodiment of the present invention.

Further, according to an exemplary embodiment of the present invention, each pattern corresponding to each of information sets necessary for three-dimensional image processing is differently generated on each light source basis. Thereby, image processing time can be reduced compared with a case of loading all information necessary for three-dimensional image processing in one pattern like the conventional art.

Further, according to an exemplary embodiment of the present invention, by considering an intensity change value of a light source according to a distance upon processing an image, an image processing error is reduced, stability of image processing can be enhanced, and a more elaborate image can be acquired.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An image acquisition device, comprising:
a pattern generator that generates a plurality of incident light patterns using a plurality of light sources and that projects the generated plurality of incident light patterns to a target object;
a pattern acquisition unit that acquires a pattern image that is formed in the target object by the plurality of incident light patterns; and
an operation unit that generates a three-dimensional image of the target object using the pattern image.

2. The image acquisition device of claim 1, wherein the plurality of light sources have different frequency bands, and
the plurality of incident light patterns correspond to the plurality of light sources, respectively, and are different patterns.

3. The image acquisition device of claim 2, wherein the plurality of light sources comprise a first light source having a first frequency band and a second light source having a second frequency band, and
the pattern generator comprises:
a first lens that concentrates light from the first light source;
a first optical diffraction unit that generates a first incident light pattern of the plurality of incident light patterns by diffracting light that is concentrated by the first lens; and
a first mirror that reflects only the first incident light pattern having the first frequency band.

4. The image acquisition device of claim 3, wherein the pattern generator further comprises:
a second lens that concentrates light from the second light source; and
a second optical diffraction unit that generates a second incident light pattern of the plurality of incident light patterns by diffracting light that is concentrated by the second lens,
wherein the second incident light pattern is transmitted through the first mirror.

5. The image acquisition device of claim 4, wherein the pattern generator further comprises a third lens that receives an input of the first incident light pattern that is reflected by the first mirror and the second incident light pattern that is transmitted through the first mirror to project the first incident light pattern and the second incident light pattern to the target object.

6. The image acquisition device of claim 5, wherein the first lens and the second lens are collimator lenses.

7. The image acquisition device of claim 4, wherein the first optical diffraction unit comprises a plurality of first micro-lenses that are arranged in a first pattern corresponding to the first incident light pattern, and
the second optical diffraction unit comprises a plurality of second micro-lenses that are arranged in a second pattern corresponding to the second incident light pattern.

8. The image acquisition device of claim 7, wherein the first optical diffraction unit further comprises a diffuser that diffuses light that is concentrated by the first lens to output the diffused light to the plurality of first micro-lenses.

9. The image acquisition device of claim 4, wherein the first optical diffraction unit comprises a diffractive optical element (DOE).

10. The image acquisition device of claim 3, wherein the first light source is one of a light emitting diode (LED) light source and a laser light source, and
the second light source is one of the LED light source and the laser light source.

11. The image acquisition device of claim 2, wherein the pattern acquisition unit separates the pattern image to an image corresponding to each of the plurality of light sources.

12. The image acquisition device of claim 11, wherein the plurality of light sources comprise a first light source having a first frequency band and a second light source having a second frequency band,
the pattern acquisition unit comprises
a first mirror that reflects only light of the first frequency band, and
a first image sensor that acquires a first image corresponding to the first light source of the pattern image through light that is reflected by the first mirror.

13. The image acquisition device of claim 12, wherein the pattern acquisition unit further comprises a second image sensor that acquires a second image corresponding to the second light source of the pattern image through light of the second frequency band that is transmitted through the first mirror.

14. The image acquisition device of claim 4, wherein the first incident light pattern is one of a non-uniform pattern and a uniform pattern, and
the second incident light pattern is one of a non-uniform pattern and a uniform pattern.

15. The image acquisition device of claim 1, wherein the plurality of incident light patterns each correspond to each of different information sets necessary for generating the three-dimensional image.

16. A method of acquiring an image of an image acquisition device that acquires a three-dimensional image of a target object, the method comprising:
generating a first incident light pattern using first light of a first frequency band in which a first light source emits light;
generating a second incident light pattern different from the first incident light pattern using second light of a second frequency band in which a second light source emits light;
projecting the first incident light pattern and the second incident light pattern to the target object;
acquiring a pattern image that is formed in the target object by the first incident light pattern and the second incident light pattern; and
generating a three-dimensional image of the target object using the pattern image.

17. The method of claim 16, wherein the generating of a first incident light pattern comprises:
concentrating the first light from the first light source through a first lens;
generating the first incident light pattern by diffracting the concentrated first light through a first optical diffraction element; and
reflecting the first incident light pattern of the first frequency band through a first dichroic mirror.

18. The method of claim 17, wherein the generating of a second incident light pattern comprises:
concentrating the second light from the second light source through a second lens;
generating the second incident light pattern by diffracting the concentrated second light through a second optical diffraction element; and
transmitting the second incident light pattern of the second frequency band through the first dichroic mirror.

19. The method of claim 16, wherein the acquiring of a pattern image comprises:
acquiring a first pattern image corresponding to the first light source from the pattern image by reflecting the first light through a first dichroic mirror; and
acquiring a second pattern image corresponding to the second light source from the pattern image by transmitting the second light through the first dichroic mirror.

20. A pattern generator that forms an image acquisition device that acquires a three-dimensional image of a target object and that generates an incident light pattern that is projected to the target object, the pattern generator comprising:
a first lens that concentrates first light of a first frequency band from a first light source;
a second lens that concentrates second light of a second frequency band from a second light source;
a third lens that concentrates third light of a third frequency band from a third light source;
an optical diffraction unit that generates a first incident light pattern by diffracting first light that is concentrated by the first lens, that generates a second incident light pattern by diffracting second light that is concentrated by the second lens, and that generates a third incident light pattern by diffracting third light that is concentrated by the third lens;
a first dichroic mirror that reflects only the first incident light pattern; and
a second dichroic mirror that reflects only the second incident light pattern,
wherein the second incident light pattern is transmitted through the first dichroic mirror, the third incident light pattern is transmitted through the first and second dichroic mirrors, and
the first to third incident light patterns are different patterns.
